(19) United States
(12) Patent Application Publication
(10) Pub. No.: US 2014/0257981 A1
(43) Pub. Date: Sep. 11, 2014

(54) SYSTEM FOR DISTRIBUTING SAMPLE GOODS

(71) Applicant: CMSSYSTEM CO., LTD., Seoul (KR)

(72) Inventor: Kyong In BAEK, Gyeonggi-do (KR)

(73) Assignee: CMSSYSTEM CO., LTD., Seoul (KR)

(21) Appl. No.: 14/194,716

(22) Filed: Mar. 1, 2014

(30) Foreign Application Priority Data
Mar. 5, 2013 (JP) 10-2013-0023579

(51) Int. Cl. G06Q 30/02

(52) U.S. Cl. CPC G06Q 30/0255
USPC 705/14.53

(57) ABSTRACT

A system for distributing sample goods. The system may issue redeeming coupons, exchangeable for sample goods, using electronic coupon technology, and provide the redeeming coupons to customers' mobile terminals, thereby efficiently distributing the sample goods.

### CROSS-REFERENCE TO RELATED APPLICATION(S)

This application claims the benefit under 35 U.S.C. §119(a) of Korean Patent Application No. 10-2013-0023579, filed on Mar. 5, 2013, in the Korean Intellectual Property Office, the entire disclosure of which is incorporated herein by reference for all purposes.

### BACKGROUND

1. Field

The following description relates to a technique for providing sample goods, more specifically, a system for distributing sample goods.

2. Description of the Related Art

When applying an early-adopter method, which is for producing a minority of sample goods, providing some selected customers with the sample goods, surveying customer responses, prior to mass-producing and shipping new products, and then producing new products, a product manufacturer or a sales agent that sells products is capable of reducing their risk-taking. Also, providing sample goods is useful for the purpose of promoting sales of goods.

Thus, this inventor has studied electronic coupon technology for issuing redeeming coupons for sample goods, providing them to customers' mobile terminals, and efficiently distributing the sample goods, using electronic coupon technology.

As for electronic coupon-related technology, there is ‘An Electronic Coupons Service System and Method Using Local Wireless Communication’ disclosed in Korean Unexamined Patent Publication No. 10-2011-0039053 (on Apr. 15, 2011).

### SUMMARY

The following description is invented for the purpose mentioned above, and relates to a system for distributing sample goods so as to issue redeeming coupons for sample goods, provide the redeeming coupons to customers' mobile terminals by using electronic coupon technology, thereby efficiently distributing the sample goods.

In one general aspect, a system for distributing sample goods includes an information collector to collect sample goods information and customers' purchase history information from a server of a goods manufacturer, or a sales agent who sells goods; a goods recipient selector to analyze the customers' purchase history information collected from the information collector, and to select customers to whom sample goods are to be distributed; a goods redeeming coupon issuer to generate electronic coupons, exchangeable for the sample goods corresponding to the sample goods information collected from the information collector, and to send the generated electronic coupons to mobile terminals of the customers selected by the goods recipient selector; and a sent history manager to store sent history of the electronic coupons sent by the goods redeeming coupon issuer, and to feed the sent history back to the server of the manufacturer or the sales agent.

The goods recipient selector may compare a goods purchase amount or a number of goods purchased of each of the customers, and select a certain number of customers in order of a highest purchase amount or a highest number of the goods purchased to distribute the sample goods.

Other features and aspects may be apparent from the following detailed description, the drawings, and the claims.

### BRIEF DESCRIPTION OF THE DRAWINGS

FIG. 1 is a diagram illustrating an example of a network of a system for distributing sample goods according to an exemplary embodiment.

FIG. 2 is a diagram illustrating an example of a system for distributing sample goods according to an exemplary embodiment.

FIG. 3 is a flowchart illustrating an example of a procedure to issue a sample goods redeeming coupon of a system for distributing sample goods according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

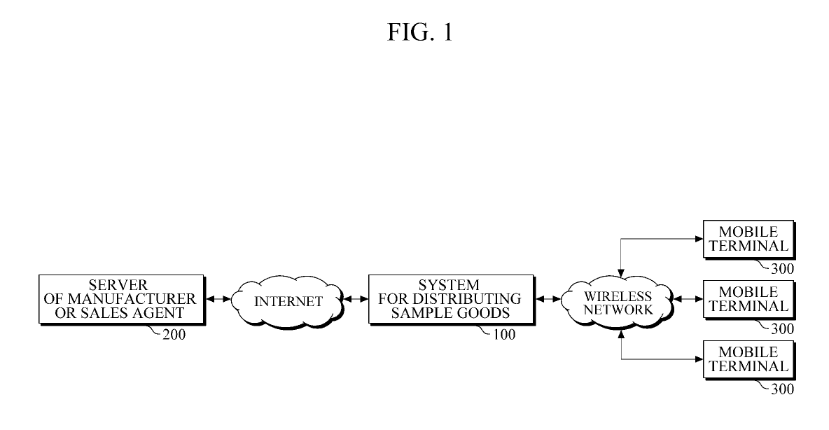

FIG. 1 is a diagram illustrating an example of a network of a system for distributing sample goods according to an exemplary embodiment. According to an exemplary embodiment as illustrated in FIG. 1, a system 100 for distributing sample goods may, in conjunction with a server 200 of a manufacturer or a sales agent through networks, collect information from the server 200, select customers to whom the sample goods are to be distributed using the collected information, and transmit electronic coupons which are exchangeable for sample goods, to the selected customers' mobile terminals 300. Thus, the system 100 enables the customers to show the sample goods redeeming coupons, acquired from their mobile terminals, to the goods manufacturer or the sales agent to receive the sample goods.

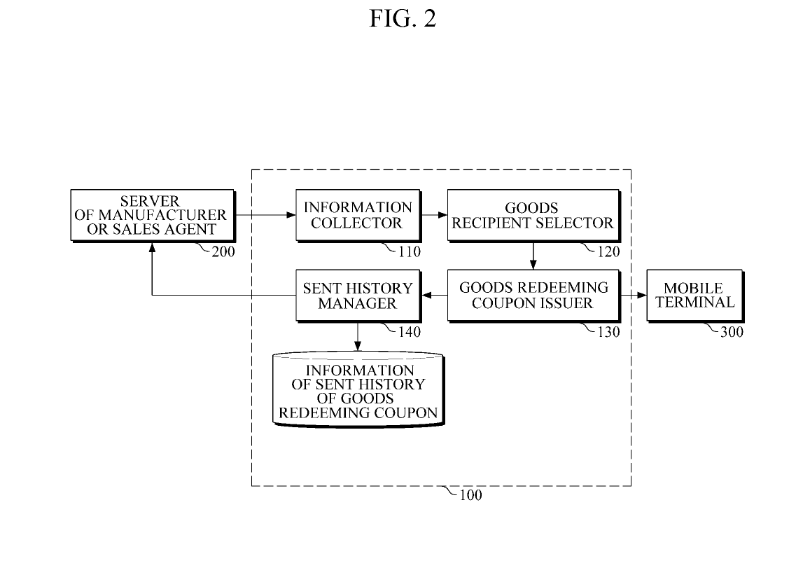

FIG. 2 is a diagram illustrating an example of a system for distributing sample goods according to an exemplary embodiment. According to an exemplary embodiment as illustrated in FIG. 2, a system 100 for distributing sample goods includes an information collector 110, a goods recipient selector, a goods redeeming coupon issuer 130, and a sent history manager 140.

The information collector 110 collects sample goods information and customers' purchase history information from a server 200 of a manufacturer or a sales agent. For example, the sample goods information may include its own goods code that identifies the goods, and each customer's purchase history information may include a goods purchase amount, or the number of goods purchased, etc.

The goods recipient selector 120 may analyze the customers' purchase history information collected from the information collector 110, and select customers to whom the sample goods are to be distributed. At this time, the goods recipient selector 120 may compare a goods purchase amount or the number of goods purchased of each of the customers, and select a certain number of customers in order of the highest goods purchase amount or the highest number of goods purchased to distribute the sample goods.

The goods redeeming coupon issuer 130 generates an electronic coupon for goods, which is exchangeable for the sample goods corresponding to sample goods information collected by the information collector 110, and sends the generated goods redeeming coupon to mobile terminals 300 of customers selected by the goods recipient selector 120.

For example, the goods redeeming coupon issuer 130 may be implemented to generate an electronic coupon for goods, which is exchangeable for the sample goods in a form of a barcode or a QR code, etc., which includes its own goods code that to identify the goods, and a coupon code to identify the goods coupon.

The sent history manager 140 stores a sent history of the goods redeeming coupon, which is sent by the goods redeeming coupon issuer 130, and feeds the sent history back to the server 200 of the manufacturer or the sales agent.

The customers who receive the goods redeeming coupons, sent by the system 100, through his/her own mobile terminals may present the redeeming coupons to the manufacturer or the sales agent, exchange them for the sample goods, and receive the sample goods.

For example, through an auto exchange device (not illustrated in FIGS. 1 and 2), which is offered to the manufacturer or the sales agent in the form of a vending machine for the sample goods, the system 100 may be implemented to identify the coupon code, included in the goods redeeming coupon, to identify the goods redeeming coupon through the customer's mobile terminal, and its own goods code to identify the goods; and to compare the identified coupon code and the coupon code included in the sent history information of the goods redeeming coupon. Then, if determined that the identified coupon code is same as the goods redeeming coupon code, the system 100 may be implemented to automatically eject the sample goods corresponding to the identified goods code, thus the customer may acquire the sample goods.

By those operations, the exemplary embodiments of a system for distributing sample goods may issue redeeming coupons for sample goods, provide the redeeming coupons to customers' mobile terminals, thereby efficiently distributing the sample goods, using electronic coupon technology.

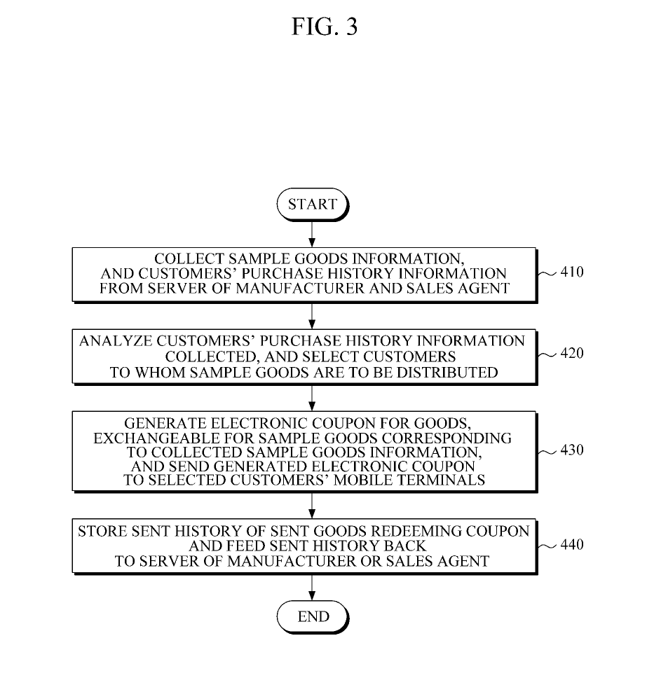

According to an exemplary embodiment as described above, an operation for issuing a goods redeeming coupon of a system for distributing sample goods is hereinafter described in FIG. 3. FIG. 3 is a flowchart illustrating an example of a procedure to issue a goods redeeming coupon of a system for distributing sample goods according to an exemplary embodiment.

First, a system for distributing sample goods collects sample goods information and customers' purchase history information from a server of a manufacturer or a sales agent in 410. The operation of collecting the sample goods information and the customers' purchase history information is described above, thus the repeated description is omitted.

Then, the system for distributing sample goods analyzes the customers' purchase history information that has been collected from the operation 410, and selects customers to whom the sample goods are to be distributed in 420. The operation of selecting the customers to whom the sample goods are to be distributed is described above, thus the repeated description is omitted.

Then, the system for distributing sample goods generates an electronic coupon for goods, exchangeable for sample goods corresponding to the sample goods information that has been collected from the operation 410, and sends the generated goods redeeming coupon to mobile terminals of the customers selected from the operation 420 in 430. The goods redeeming coupon is described above, thus the repeated description is omitted.

In addition, the system for distributing sample goods stores the sent history of the goods redeeming coupon that is sent from the operation 430, and feeds the sent history back to a server of the manufacturer or the sales agent.

Then, a user who receives the goods redeeming coupon, sent by the system for distributing sample goods, through his/her own mobile terminal may show the goods redeeming coupon to the manufacturer or the sales agent, exchange the goods redeeming coupon for the sample goods, and receive the sample goods.

By those operations, the system for distributing sample goods may issue redeeming coupons, exchangeable for sample goods by using electronic coupon technology, provide the redeeming coupons to customers' mobile terminals, thereby distributing the sample goods efficiently. So, the purpose of the exemplary embodiments mentioned above may be attained.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for distributing sample goods, the system comprising:
an information collector configured to collect sample goods information and customers' purchase history information from a server of a goods manufacturer or a sales agent who sells goods;
a goods recipient selector configured to analyze the customers' purchase history information collected from the information collector, and select customers to whom sample goods are to be distributed;
a goods redeeming coupon issuer configured to generate electronic coupons, exchangeable for the sample goods corresponding to the sample goods information collected from the information collector, and to send the generated electronic coupons to mobile terminals of the customers selected by the goods recipient selector; and
a sent history manager configured to store sent history of the electronic coupons sent by the goods redeeming coupon issuer, and to feed the sent history back to the server of the manufacturer or the sales agent.

2. The system of claim 1, wherein the goods recipient selector is configured to compare a goods purchase amount or a number of goods purchased of each of customers, and select a certain number of customers in order of a highest purchase amount or a highest number of the goods purchased to distribute the sample goods.
